(19) United States
(12) Patent Application Publication
(10) Pub. No.: US 2026/0131877 A1
(43) Pub. Date: May 14, 2026

(54) SYSTEM FOR ASSISTING IN THE RECOVERY OF AT LEAST ONE SUBMERGED OBJECT

(71) Applicant: SERCEL, CARQUEFOU (FR)

(72) Inventors: Louis GUILLOU, CARQUEFOU (FR); Emeric MENANTEAU, CARQUEFOU (FR)

(21) Appl. No.: 19/357,201

(22) Filed: Oct. 14, 2025

(30) Foreign Application Priority Data
Oct. 15, 2024 (FR) 2411162

(51) Int. Cl. B63C 7/02; B63B 22/00; G01V 1/16

(52) U.S. Cl. CPC B63C 7/02; B63B 22/00; G01V 1/168

(57) ABSTRACT

A system for assisting in raising at least one submerged object, having a buoy, a wire element deployment system with a holding device coupled to, or contained in, the buoy, and a wire element that is held in a short position and can be deployed, one end of the wire element being secured to the holding device and the other end being fastened to the at least one submerged object. A mechanical blocking and unblocking system makes it possible to block and unblock the holding device. An acoustic signal transmission system is configured to transmit an acoustic signal to a control system, in order to control the mechanical blocking and unblocking system for deploying the wire element.

### FIELD OF THE INVENTION

The present invention relates generally to systems for assisting in retrieving at least one submerged object.

The invention relates in particular to an assistance system that makes it possible to control the raising to the surface of the water of a submersible floating element to which at least one submerged object, such as a line of fishing traps or seismic sensors, also referred to as seismic nodes, or OBNs (ocean bottom nodes), is connected by a wire element, in order to allow the set of objects to be removed from the water by pulling on the wire element once part of this wire element has been raised to the surface of the water with the floating element.

### PRIOR ART

A well-known fishing technique consists in deploying, on the seabed, a collecting device, for example a line of one or more traps, associated with a floating buoy that allows it to be located and retrieved by means of the rope (line) connecting the buoy and the collecting device. However, the connecting rope may become severed, causing the collecting device to be lost; moreover, this line impedes the movement of marine species, which may be injured thereby.

The concept of the locating buoy is also used for research activities, by associating one or more sensors left for periods of varying length on the seabed with a buoy for retrieval once the measurement campaign has been carried out. In addition to the drawbacks associated with the long-term presence of the line, this approach also remains limited in terms of depth, however, and therefore other means for raising the sensors have been developed.

Thus, in the field of prospecting for natural resources, and in particular hydrocarbons, the acquisition and processing of seismic data may be used to generate a profile, or image, of the geophysical structure of a bedrock. Seismic data are obtained by sending artificially generated seismic or acoustic interrogation waves (vibration, impulsive shock, etc.) deep beneath the surface. Seismic sensors are used to measure the propagation and the reflections and refractions of the artificially generated seismic waves by the different layers of the bedrock, and some may be placed directly on the seabed floor in order to take seismic readings at the seabed, as described in documents U.S. Pat. Nos. 9,381,984 and 4,967,683.

These types of OBN sensors are usually dropped into the ocean, descend to rest on the seabed under their own weight, and record the seabed activity. Once the surveillance campaign has been completed, an external command is received by the recorder, which triggers the jettisoning of ballast associated therewith, which allows the recorder to rise to the surface as described in application EP1217390. The recorder can then be retrieved at the surface. One retrieval solution is described, for example, in application WO2022/195233.

Among other existing solutions, document DE102015204918 describes an undersea-cable storage device for retrieving objects while avoiding the formation of loops and knots, which comprises a system for opening a hook eyelet in order to release a cable section.

Document CA3229186 describes an underwater retrieval device for retrieving an underwater instrument. The device comprises a buoyancy means, a cable reel, a control device configured to receive an external signal, a release mechanism in communication with the control device, and a locking mechanism configured to lock the cable reel. The locking mechanism may comprise a locking pin that can engage with the cable reel, a locking lever urged into an unlocked configuration, and a latch for fixing the locking lever in the locked configuration.

However, the existing systems for triggering the raising of these devices or other seismometers are complex and consume a lot of energy. For example, submersible buoys released by an electric piston or motor, or buoys that are inflatable by compressed air, are energy intensive and difficult to implement.

The aim of the present invention is to propose a novel system for assisting in retrieving at least one submerged object, such as a seismic sensor or fishing gear, that makes it possible to at least partially overcome one or more of the problems set out above.

### SUMMARY OF THE INVENTION

To this end, the invention relates to a system for assisting in retrieving at least one submerged object, such as a fishing trap or seismic sensor, from the bottom of a body of water; the assistance system comprising:
a submersible floating element;
a wire element deployment system with a wire element held in a short position by a holding device, and that can be deployed, of which the first end is secured to the holding device and the other end is fastened to said at least one submerged object;
a mechanical blocking and unblocking system for preventing and respectively allowing the deployment of the wire element by virtue of a control system that is actuated by an acoustic signal transmission system, which can be submerged at the surface. The mechanical blocking and unblocking system comprises a rod mounted so as to be able to move between a position referred to as armed position, which prevents the deployment of the wire element, and a position referred to as disarmed position, which releases the wire element, and a rod moving system comprising an electromagnet that, when supplied with electrical power, is configured to disarm the rod.

Such a design of the retrieval assistance system, which enables the unblocking of the deployment system and therefore the release of the wire element to be activated by an acoustic signal controlled from the surface, makes it possible to raise the buoy with reduced electrical energy consumption. The risk of system failure is limited and the system makes it possible to avoid the wire element being permanently in the water column for the entire time said at least one object is submerged.

The system makes it possible, for example, to minimize the environmental impact of fishing or seismic acquisition or exploration campaigns, by avoiding collisions of marine species with lines, and by eliminating breakages of lines that generate waste that is left in the oceans.

Coupling the holding device to the buoy may include securing the holding device to the buoy or connecting the holding device to the buoy. The holding device being coupled to the buoy or the holding device being contained in the buoy means that, when the holding device is unblocked so that the wire element connecting the holding device to said at least one submerged object can be deployed, the upward thrust force of the buoy brings the holding device with it, said holding device accompanying the buoy as it is raised, while allowing the wire element to be deployed.

More specifically, the system is defined in the claims.

In document CA3229186, it is a permanent magnet that, by applying its permanent magnetic field to a ferromagnetic element fastened to a lever carrying a pin, holds the pin in an orifice of a drum or reel.

Document CA3229186 then makes use of an electromagnetic coil to counteract the field of the permanent magnet, thus requiring significant energy consumption to counteract the field of the permanent magnet.

In a marine environment, because of the corrosion to which the ferromagnetic element is exposed, it is necessary for the ferromagnetic element to have large dimensions, particularly in terms of thickness, in order to avoid degradation of the system. The permanent magnet must then be selected so as to generate a large electromagnetic field in order to be able to retain the ferromagnetic element.

As a result, in the system of document CA3229186, a large amount of power is thus also consumed by the electromagnetic coil in order to counteract the field of the permanent magnet, and to allow the ferromagnetic element to escape from the permanent magnet.

Conversely, in the solution according to the invention, using an electromagnet to trigger a mechanical action (in particular the movement of the movable core of the electromagnet that moves the holding member relative to the finger into the position for releasing the finger, preferably via a mechanical connection system, such as a system of connecting rods) enables the return movement of the finger, which is preloaded by a spring, to be released, this consuming little energy.

The electromagnet makes it possible to deactivate the mechanical blocking of the finger by moving the holding member relative to the finger, and thus to allow the finger to return to the disarmed position while consuming little energy, since a small electrical pulse is sufficient to move the holding member (relative to the finger) into the inactive position, and to allow the finger, which is preloaded by the spring, to pass into the retracted/disarmed position so that the finger escapes from the holding device.

The system may also comprise one or more of the features defined in the dependent claims, taken in any technically acceptable combination.

In particular, according to one embodiment, the rod, or finger, is mounted so as to be able to slide between said armed position and said disarmed position.

The kinematics provided for returning the finger to the retracted/disarmed position include a translational (or sliding) movement of the spring-loaded finger, which allows the finger to escape from the part of the holding device it blocks, more reliably than a pivoting movement of a pin relative to the drum as provided in document CA3229186 for removing the pin from the orifice formed in the drum. The kinematics of the system according to the invention reduce the risk of the finger becoming trapped relative to the holding device.

According to one embodiment, the mechanism for moving the holding member does not have a permanent magnet.

The absence of a permanent magnet makes it possible to limit the bulk and weight of the system. The absence of a permanent magnet also avoids the emission of a permanent magnetic field, thus reducing the risk of disturbance to the marine environment.

According to one embodiment, the electromagnet comprises:
a body, which includes a coil and delimits an open housing at one end;
a core, referred to as movable shaft, mounted so as to be able to move in and along said housing;
the coil extending around the core, over at least part of the length of the core, such that supplying electrical power to the coil generates a force that moves the core, for example in the direction of retraction into the body, in order to actuate the mechanical connection system and thus to move the holding member, relative to the finger, into the position for releasing the finger.

According to one particular aspect, the core is at least partly housed in said body of the electromagnet and carried by the body of the electromagnet inside which it is slidably mounted. In other words, the body of the electromagnet has a housing inside and along which the core is slidably mounted, and the core is moved when power is supplied to the coil, which is triggered following reception of an acoustic signal.

The movement of the core mechanically causes the holding member to move into a position away from the finger so that the finger is no longer retained by the holding member and the spring returns the finger to the retracted position in which the holding device is no longer blocked by the finger.

The invention also relates to a mechanical blocking and unblocking system for a wire element deployment system for assisting in retrieving at least one submerged object, such as a fishing trap or seismic sensor, from the bottom of a body of water; the wire element deployment system comprises a wire element fastened at one end to said object and at the other end to a holding device configured, when locked, to allow the wire element to be held in a short position and, when locked, to allow the wire element to be deployed;

the mechanical blocking and unblocking system being configured to be connected to a control system of the holding device upon receiving a signal transmitted by an acoustic signal transmission system submerged at the surface, wherein the mechanical blocking and unblocking system comprises a finger that can move between:

an armed position, in which it can interact with a part of the holding device to prevent the deployment of the wire element, and a disarmed position in which it is returned by a spring in order to move away from the holding device and allow the wire element to be released;

the mechanical blocking and unblocking system also comprising an electromagnet, which is configured, when supplied with electrical power by a battery, to release the finger.

According to one embodiment, said mechanical blocking and unblocking system is in one piece. It may comprise a mechanical connection system connected on one side to the core of the electromagnet, and on the other side to a member for holding the finger.

In other words, all the components of the mechanical blocking and unblocking system are mounted in or fastened to a single casing that is separate from the wire element deployment system, in particular separate from the holding device, for example a drum, without one or more of these components being carried by the wire element deployment system.

The mechanical blocking and unblocking system can thus be easily installed for controlling the blocking/unblocking of the wire element deployment system, and can also be easily removed for replacement in the event of maintenance/repair.

When the mechanical blocking and unblocking system is deactivated (i.e. when the finger is retracted relative to the corresponding element of the holding device), the ability of the holding device to move is unblocked, and for example the holding device, such as a drum, can pivot freely relative to the mechanical blocking and unblocking system. According to one particular aspect, the mechanical blocking and unblocking system comprises a body, which forms a casing in which the electromagnet is housed. The mechanical blocking and unblocking system forms a one-piece device that is separate from the drum.

In other words, the mechanical blocking and unblocking system forms a module that can be combined with an existing wire element deployment system in order to allow or prevent the pivoting of the holding device and/or without having to fasten elements of the mechanical blocking and unblocking system to the wire element deployment system. In particular, the holding device does not carry any elements of the mechanical blocking and unblocking system. Conversely, in document CA3229186, the permanent magnet and the coil that are used to retain and release the pin are secured to the drum.

The design of the mechanical blocking and unblocking system, all the components of which are housed in the same casing or body, allows varied applications, and may be easily reused in different devices. Conversely, in document CA3229186, part of the blocking and unblocking system, such as the permanent magnet, is secured inside of the drum. The blocking and unblocking system provided in CA3229186 is therefore dedicated to the device formed by the drum, and cannot be used in the form of a module that can be applied to different devices without said device being modified.

The system may also comprise one or more of the features of the embodiments presented hereinabove taken in any technically acceptable combination.

### BRIEF DESCRIPTION OF THE DRAWINGS

Other features and advantages of the invention will become more apparent from the following description, which is purely illustrative and non-limiting and should be read in conjunction with the appended drawings, in which:

FIG. 1 is a schematic view of a system for assisting in retrieving submerged objects, which shows a submersible buoy connected to submerged objects by a wire element, such as a cable, held in a short position by a mechanical blocking system so that the wire element is prevented from being deployed, thus holding the buoy at the bottom of a body of water under the weight of the submerged objects, the assistance system also comprising an acoustic signal transmission system that is linked to a boat and intended to be submerged at the surface in order to be able to transmit a signal for unblocking the cable to a corresponding receiving system;

FIG. 2 is a view of FIG. 1 with the wire element deployed, which has allowed the buoy to be raised to the surface, thus allowing an operator to grasp the upper part of the wire element to be able to pull it up in order to lift the submerged objects;

FIG. 3 is a sectional view of a blocking system for blocking the deployment of the wire element, with a blocking finger in the armed position in accordance with one embodiment;

FIG. 4 is a sectional view of the blocking system in FIG. 3, with the blocking finger in the disarmed position, in accordance with one embodiment.

### DETAILED DESCRIPTION

Embodiments are described below with reference to the appended drawings. Similar numbers refer to similar elements throughout the drawings. However, the invention may be implemented in many different forms and should not be interpreted as being limited to the embodiments set out here. The scope of the invention is defined by the appended claims.

Reference throughout the specification to “an/one embodiment” means that a particular function, structure or feature described in relation to one embodiment is included in at least one embodiment of the present invention. The occurrence of the expression “in an/one embodiment” in various places throughout the specification thus does not necessarily refer to the same embodiment. Furthermore, the particular functions, structures or features can be combined in any suitable manner in one or more embodiments.

A system for assisting in retrieving at least one submerged object 9 from the bottom of a body of water is proposed. Said at least one submerged object 9 is, for example, a line of several fishing traps or a set of seismic sensors 900, 901, 902.

The assistance system comprises a submersible floating element 8, referred to as a buoy. The buoy preferably comprises a foam rather than a gas to ensure its buoyancy, so that it can be submerged to a sufficient depth without damage, until a command to raise it to the surface is transmitted.

The assistance system also comprises a system 7 for releasing a wire element 71. In one advantageous embodiment, the release system 7 comprises a drum 72 and a wire element 71 that is wound onto the drum 72 and can be unwound. The wire element 71 has one end 712 fastened to the drum 72 and the other end 719 fastened to said at least one submerged object 9. The wire element 71 could be held in this short position, i.e. the distance between the end 719 fastened to the submerged object 9 and the other end 712 is much shorter than the length of the wire element 71, by another release system 7, such as by being folded in a particular manner or even being held loose in a suitable housing, depending on the nature and length of the wire element 71.

The assistance system comprises a mechanical blocking and unblocking system 6 for blocking and unblocking the release system 7 and, in the illustrated preferred embodiment, configured to block and unblock the ability of the drum 72 to rotate in order to prevent and respectively allow the unwinding of the wire element 71. A control system 5 is connected to the mechanical blocking and unblocking system 6. As explained below, the control system 5 is connected to the mechanical blocking and unblocking system 6 by an electrical cable 56 for supplying power to an electromagnet 66 in order to unblock the deployment of the wire element 71.

The assistance system also comprises an acoustic signal transmission system 4 configured to transmit, through the body of water, an acoustic signal S45 that can be received by the control system 5 located at the bottom of the body of water. Said control system 5 is configured, upon receiving said acoustic signal, to control the mechanical blocking and unblocking system 6.

The acoustic signal transmission system 4 comprises an acoustic signal transmission device 42, and a radio communication device 41 configured to receive an instruction signal transmitted by a terminal 2, such as a tablet. The radio communication device 41 may comprise a WiFi communication module 411.

The acoustic signal transmission device 42 is configured, upon receiving said instruction signal, to transmit the acoustic signal S45 to the control system 5. The acoustic signal transmission device 42, which is designed to be placed in the water while remaining at the surface, is preferably an acoustic modem, for example a MATS device manufactured by Sercel. Preferably, the radio communication device 41 is connected to the acoustic signal transmission device 42 by a cable with a length suitable for enabling the radio communication device 41 to be held on the boat while the acoustic signal transmission device 42 is placed in the water.

Advantageously, the control system 5, which is intended to be submerged at the bottom of the body of water with said at least one object 9, also comprises a second acoustic modem or another MATS device, which is designed to be equipped with an electric battery 53 and a processing unit 52 configured to generate an electrical pulse for activating the electromagnet 66 as explained below.

Preferably, the acoustic signal transmission device 42 is supplied with electrical power by a battery 412 contained in the radio communication device 41.

The acoustic signal transmission device 42 can thus be submerged at the surface while remaining connected to a boat. In particular, during an operation of retrieving said at least one object 9, provision may be made for the acoustic signal transmission device 42 of the acoustic signal transmission system 4 to be placed in the water while remaining connected to the boat by a cable, for example by a connecting cable between the acoustic signal transmission device 42 and the communication device 41, which remains on the boat.

The control system 5 comprises an acoustic signal receiving device 51, a processing unit 52 and a battery 53.

The processing unit 52 of the control system 5 is configured, upon receiving the acoustic signal S45, to control the generation, using the battery 53, of an electrical pulse that makes it possible to actuate the mechanical blocking and unblocking system 6, in particular in the direction of unblocking the rotation of the drum 72, in order to allow the unwinding of the wire element 71. Advantageously, the battery is rechargeable.

The mechanical blocking and unblocking system 6 comprises a blocking device, which comprises a body 61 and a rod 62, referred to as a finger. The finger is mounted so as to be able to move between a position referred to as armed position and a position referred to as disarmed position. The finger 62 is returned to the disarmed position by a spring 63.

The finger 62 may be provided with seal(s) 621 in order to provide sealing between the finger 62 and the body 61. The hollow body 61 may be formed by assembling a plurality of parts, and seals 611 may be used to provide sealing.

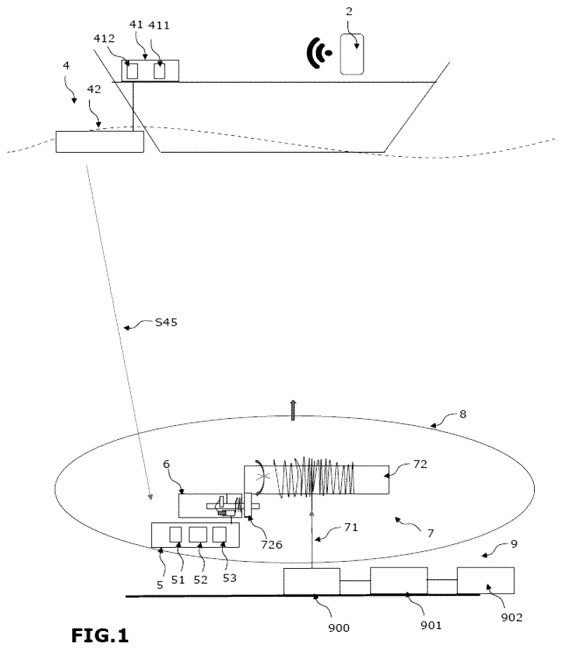

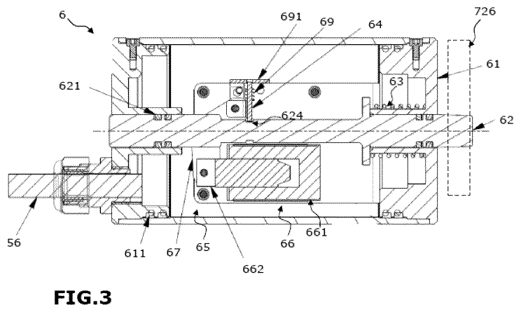

In the armed position, the finger 62 has a part projecting from the body 61, which interacts with a part 726 of the drum 72, such as one or more fins 726 fastened to the body of the drum 72, in order to form an anti-rotation stop for stopping the drum from rotating in the unwinding direction of the wire element 71 (see for example FIG. 1 and FIG. 3). If the deployment system 7 is, for example, a housing provided with a clip for holding the wire element in the housing, the finger 62 interacts with the clip to open it or loosen it or break it. Other alternatives are possible.

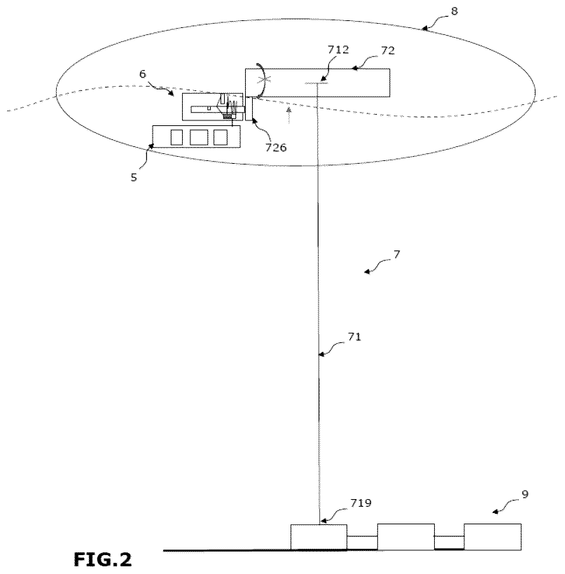

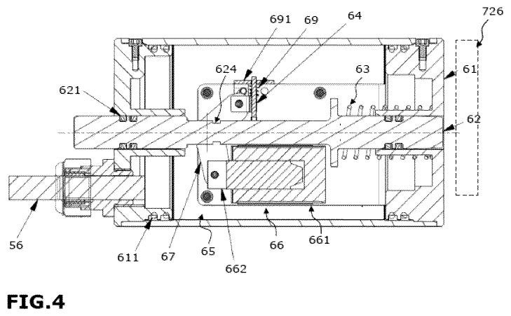

In the disarmed position, the part of the finger 62 that formed an anti-rotation stop is moved away from said part 726 of the drum 72 so that the drum 72 is free to rotate. As a result, because the buoy 8 pulls on the drum 72 in the raising direction and the drum 72 is now free to rotate on itself in the unwinding direction of the wire element 71, the wire element 71 unwinds, allowing the drum 72 and the buoy 8 to rise to the surface (see for example FIG. 2 and FIG. 4).

The mechanical blocking and unblocking system 6 comprises a holding member 64 for holding the finger in the armed position, which can move between a position for holding the finger in the armed position, and a position for releasing the finger. Provision is also made for a mechanism 65 for moving the holding member 64 (relative to the finger) into the position for releasing the finger.

According to one embodiment, which is for example illustrated in FIGS. 3 and 4, the holding member 64 is mounted so as to be able to slide, preferably in a direction orthogonal to the movement direction for releasing the finger 62, between:
said holding position in which the holding member 64 engages in a groove 624 of the finger 62, preventing the finger 62 from moving axially;
said release position in which the holding member 64 is disengaged from the groove 624 of the finger 62 so as to allow the finger 62 to move axially and thus allow the finger 62 to be returned to the deactivated position by the return spring 63.

The holding member 64 is mounted so as to be able to slide between the position for locking the finger in the armed position and the position for releasing the finger, which allows the finger 62 to return to the disarmed (retracted) position that allows the unwinding of the wire element 71.

The mechanism 65 for moving the holding member 64 into the position for releasing the finger comprises an electromagnet 66 and, advantageously, a mechanical connection system 67 between the electromagnet 66 and the holding member 64, connected on one side to a movable shaft of the electromagnet, referred to as the core 662, and on the other side to the holding member 64.

The mechanical blocking and unblocking system 6 of the release system 7, in particular the mechanism 65 for moving the holding member 64, does not have a permanent magnet.

The electromagnet 66 is configured, when supplied with electrical power, to bring the holding member 64 into the position for releasing the finger 62, advantageously by actuating the mechanical connection system 67.

In particular, the electromagnet 66 comprises a body 661, which includes a coil that extends around the core 662, over at least part of the length of the core, such that supplying electrical power to the coil generates a force that moves the core 662, for example in the direction of retraction into the body 661, thus advantageously actuating the mechanical connection system 67 and moving the holding member 64 into the position for releasing the finger 62. According to one particular aspect, the axis of the movable core is parallel and preferably coaxial with the axis of the coil.

The movement of the core 662 mechanically causes the holding member 64 to move into a position away from the finger 62, in particular from the groove (or notch) 624 of the finger 62, so that the finger 62 is no longer retained by the holding member 64 and the spring 63 returns the finger 62 to the retracted position in which the drum 72, in particular the part 726, is no longer blocked by the finger.

In other words, the electromagnet 66 makes it possible to deactivate the mechanical blocking of the finger 62 by moving the holding member 64 relative to the finger 62, and thus to allow the finger 62 to return to the disarmed position while consuming less energy, since a small electrical pulse is sufficient to move the holding member 64 into the inactive position, and to allow the finger 62, which is preloaded by the spring 63, to pass into the retracted/disarmed position so that the finger 62 escapes from the element 726 of the holding device 72.

The electromagnet 66 is connected to an electrical cable 56, which is connected to the battery 53 of the system 5 in order to enable the electromagnet 66 to be electrically controlled (preferably by an electrical pulse).

In the embodiment illustrated in the figures, when the electromagnet 66 is supplied with power, the core 662 moves the mechanical connection system 67, which drives the holding member 64 into the position for releasing the finger, so that the holding member 64 exits the notch 624, and the return spring 63 brings the finger 62 into the disarmed position. The part 726 of the drum 72 is thus free to rotate relative to the finger 62, and the drum 72 can rotate freely in the unwinding direction of the wire element 71.

The mechanical connection system 67 between the electromagnet 66 and the holding member 64 comprises a system of connecting rods 67.

Thus, the electromagnet 66 can be powered by a short-duration electrical pulse generated by the control system 5 upon receiving the acoustic signal S45 corresponding to a disabling command, transmitted by the acoustic signal transmission system 4 at the surface, which itself has received an instruction to transmit said command transmitted by the terminal 2, such as a tablet, via the radio communication device 41 connected to the acoustic transmission device 42.

For undersea use, the electromagnet 66 is housed, preferably together with the mechanical connection system 67 and the holding member 64, in a sealed enclosure or casing 61.

The holding member 64, also referred to as a yoke, is returned to the position for holding the finger in the armed position by a return spring 69, in order to make it easier to reset the finger. The return spring of the blocking member in the holding (locking) position limits the risk of the finger being released and therefore accidentally disarmed. The return spring 69 may be carried by a flange 691 as illustrated, for example, in FIG. 3 or in FIG. 4.

The configuration of the assembly of the electromagnet 66, if necessary of the mechanical connection system 67, and of the holding member 64 makes it possible, when the acoustic signal S45 is transmitted, to bring the holding member 64 into the disabling position with a reduced amount of energy.

The distance by which the finger 62 extends between its extended position and its retracted position is greater than the distance by which the member 64 is required to move in order for the holding member 64 to pass from the armed position to the disabling position.

Using a finger 62 that, when extended, is loaded by a spring 63 and controlling the finger 62 to return to the retracted position, by retracting the holding member 64 by means of the electromagnet 66, advantageously via the mechanical connection system 67, makes it possible, by means of a small movement controlled by the electromagnet 66 that requires little power and therefore reduced bulk and weight, to obtain a large movement of the finger 62 as a result of being returned to the retracted position by the spring 63. This large movement of the finger 62 enabled by the return spring 63 and by a small movement of the holding member 64 makes it possible, during arming, to cause the finger 62 to extend by a sufficient length for interacting with the drum 72.

According to one embodiment, as illustrated for example in FIG. 1 or 2, the drum 72 is located inside the buoy 8, and the wire element 71, which is wound onto the drum 72, has a part that extends out of the buoy 8 and is connected to said at least one submerged object 9.

The terminal 2, which is configured to communicate with the radio communication device 41, comprises a processor and a computer program that can be executed by said processor. The computer program, also referred to as an application, enables an operator to trigger the sending, to the acoustic signal transmission system 4, of an instruction signal corresponding to an instruction to raise the submersible floating element, in order to trigger the sending, by said acoustic signal transmission system 4, of said acoustic signal S45 to the control system 5 that controls the mechanical blocking and unblocking system 6. In particular, upon receiving the acoustic signal S45, the system 5 controls the battery 53 to supply electrical power to the electromagnet 66, in order to trigger the passage of the finger 62 into the disarmed position. Preferably, the battery 53 supplies electrical power to the electromagnet 66 by generating an electrical pulse, controlled by the processing unit 52, which actuates the electromagnet 66.

The mechanical blocking and unblocking system 6 thus forms a resettable finger system, which is disarmed mechanically with a low electrical consumption in order to actuate the electromagnet that affects the movement of the holding member 64. Specifically, the electromagnet can be activated by a short-duration electrical pulse, thus allowing a minimal consumption of energy.

This system is particularly useful in the context of fishing or seismic sensors, where it is necessary to be able to raise objects to the surface without a line being permanently present at the surface and in the water column, in order to protect marine fauna, in particular whales and other cetaceans.

The holding member 64 prevents the wire element 71 from being unwound when the finger 62 is in the armed position. When the finger 62 is disarmed, the unwinding of the wire element 71 is enabled so that the buoy 8 can rise at the same time as the wire element 71 is unwound, thus allowing an operator on the surface to grab a part of the wire element 71 that is connected to the buoy to pull on the wire element in order to lift the one or more submerged objects 9 attached to the other end of the wire element.

Once it has risen to the surface, the buoy 8 serves as a position indicator for an operator on the boat who can thus grasp the wire element 71 connected to the buoy to retrieve the one or more objects 9.

The interaction of the armed finger with the drum (or reel) so as to block the rotation of the drum or with another blocking means, and thus prevent the deployment of the wire element 71, makes it possible to hold the wire element 71 in the short position, and therefore keep the buoy 8 submerged until the finger 62 is disarmed.

The system can be reused by storing the wire element 71 again in the deployment system (around the drum 72 or in the housing, in particular) and by reactivating the finger 62 in order to block the rotation of the drum 72 or another means and thus allow one or more other objects connected to said wire element 71 to be submerged at the bottom of the body of water with a view to being subsequently retrieved.

This system makes it possible to bring to the surface the buoy 8 to which the one or more submerged objects 9 are connected, with minimal energy consumption and excellent reliability.

According to one embodiment, said mechanical blocking and unblocking system 6 is in one piece.

In other words, all the components of the mechanical blocking and unblocking system 6 are mounted in or fastened to a single casing that is separate from the wire element 71 deployment system 7, in particular separate from the holding device 72, for example a drum, without one or more of these components being carried by the wire element 71 deployment system 7.

The mechanical blocking and unblocking system 6 can thus be easily installed for controlling the blocking/unblocking of the wire element 71 deployment system 7, and can also be easily removed for replacement in the event of maintenance/repair.

When the mechanical blocking and unblocking system 6 is deactivated (i.e. when the finger 26 is retracted relative to the element 726), the element 726, and therefore the drum 72, can pivot freely relative to the mechanical blocking and unblocking system 6.

The mechanical blocking and unblocking system 6 comprises a body 61, which forms a casing in which the electromagnet 66 is housed.

The mechanical blocking and unblocking system 6 forms a one-piece device that is separate from the drum 72. In other words, the mechanical blocking and unblocking system 6 forms a module that can be combined with an existing wire element 71 deployment system 7 in order to allow or prevent the pivoting of the holding device 72 and/or without having to fasten elements of the mechanical blocking and unblocking system 6 to the wire element 71 deployment system 7. In particular, the holding device 72 does not carry any elements of the mechanical blocking and unblocking system 6.

The or each processing or driver unit takes the form, for example, of a processor and a data storage memory in which computer instructions that can be executed by said processor are stored, or in the form of a microcontroller.

In other words, the functions and steps described may be implemented in the form of a computer program or via hardware components (for example, programmable gate arrays). In particular, the functions and steps performed may be carried out by sets of instructions or computer modules implemented in a processor or controller or may be carried out by dedicated electronic components or components of the programmable logic circuit (or FPGA standing for field-programmable gate array) type or of the application-specific integrated circuit (ASIC) type. It is also possible to combine computer parts and electronic parts.

The processing or driver unit is thus an electronic and/or computer unit. When it is stated that said unit is configured so as to perform a given operation, this means that the unit comprises computer instructions and the corresponding execution means that make it possible to perform said operation and/or that the unit comprises corresponding electronic components.

The invention is not limited to the embodiments illustrated in the drawings.

Consequently, it must be understood that, where the features mentioned in the appended claims are followed by reference signs, these signs are included solely for the purpose of improving the intelligibility of the claims and in no way limit the scope of the claims.

Furthermore, the term “comprising” does not rule out other elements or steps. In addition, features or steps that have been described with reference to one of the embodiments set out above may also be used in combination with other features or steps of other embodiments set out above.

1. An assistance system for retrieving at least one submerged object from the bottom of a body of water; the assistance system comprising:
a submersible floating element, referred to as a buoy;
a wire element deployment system comprising a holding device coupled to, or contained in, the buoy, and a wire element that is held in a short position, in which the distance between two ends of the wire element is less than the length of the wire element, by the holding device, and can be deployed,
the first end of the wire element being secured to the holding device and the other end being fastened to said at least one submerged object;
a mechanical blocking and unblocking system configured to block and unblock the holding device, for preventing and respectively allowing the deployment of the wire element,
a control system connected to the mechanical blocking and unblocking system configured to control the unblocking of the holding device;
an acoustic signal transmission system, which can be submerged at the surface, configured to transmit an acoustic signal that can be received by the control system, said control system being configured, upon receiving said acoustic signal, to control the mechanical blocking and unblocking system for deploying the wire element;
wherein the mechanical blocking and unblocking system comprises a blocking device comprising a rod, referred to as a finger, mounted so as to be able to move between:
a position referred to as armed position, in which the finger interacts with a part of the holding device that prevents the deployment of the wire element, and
a position referred to as disarmed position in which the finger is moved away from said part of the holding device so that the wire element is released; the finger being returned to the disarmed position by a spring;
the mechanical blocking and unblocking system also comprising:
a holding member for holding the finger in the armed position, which can move between a position for holding the finger in the armed position, and a position for releasing the finger;
a mechanism for moving the holding member into the position for releasing the finger;
wherein the mechanism for moving the holding member comprises an electromagnet; the electromagnet being configured, when supplied with electrical power, to bring the holding member into the position for releasing the finger.

2. The system as claimed in claim 1, wherein the mechanism for moving the holding member also comprises a mechanical connection system between the electromagnet and the holding member, connected on one side to a movable shaft of the electromagnet, referred to as the core, and on the other side to the holding member,
the electromagnet being configured, when supplied with electrical power, to actuate the mechanical connection system so as to bring the holding member into the position for releasing the finger.

3. The system as claimed in claim 2, wherein the electromagnet comprises:
a body, which includes a coil and delimits an open housing at one end;
a core, referred to as movable shaft, mounted so as to be able to move in and along said housing;
the coil extending around the core, over at least part of the length of the core, such that supplying electrical power to the coil generates a force that moves the core in order to actuate the mechanical connection system and thus to move the holding member, relative to the finger, into the position for releasing the finger.

4. The system as claimed in claim 2, wherein the mechanical connection system between the electromagnet and the holding member comprises a system of connecting rods.

5. The system as claimed in claim 1, wherein the finger is mounted so as to be able to slide between said armed position and said disarmed position.

6. The system as claimed in claim 1, wherein the mechanism for moving the holding member does not have a permanent magnet.

7. The system as claimed in claim 1, wherein the acoustic signal transmission system comprises:
an acoustic signal transmission device, and
a radio communication device configured to receive an instruction signal transmitted by a terminal,
the acoustic signal transmission device being configured, upon receiving said instruction signal, to transmit the acoustic signal to the control system.

8. The system as claimed in claim 7, wherein the system comprises said terminal, said terminal comprising a processor and a computer program that can be executed by said processor, enabling an operator to trigger the sending, to the acoustic signal transmission system, of an instruction signal corresponding to an instruction to raise the submersible floating element, in order to trigger the sending, by said acoustic signal transmission system, of said acoustic signal to the control system that controls the blocking and unblocking system.

9. The system as claimed in claim 1, wherein the control system comprises an acoustic signal receiving device, a processing unit and a battery.

10. The system as claimed in claim 9, wherein the processing unit of the control system is configured, upon receiving the acoustic signal, to control the generation, using the battery, of an electrical pulse that makes it possible to actuate the mechanical blocking and unblocking system in the unblocking direction in order to allow the deployment of the wire element.

11. The system as claimed in claim 1, wherein the holding member, also referred to as a yoke, is returned to the position for holding the finger in the armed position by a return spring.

12. The system as claimed in claim 1, wherein the holding member is mounted so as to be able to slide between:
said holding position in which the holding member engages in a groove of the finger, preventing the finger from moving axially;
said release position in which the holding member is disengaged from the groove of the finger so as to allow the finger to move axially and thus allow the finger to be returned to the disarmed position by the return spring.

13. The system as claimed in claim 12, wherein the holding member is mounted so as to be able to slide in a direction orthogonal to the movement direction for releasing the finger.

14. The system as claimed in claim 1, wherein the holding device comprises a drum around which the wire element is wound, and the blocking and unblocking system interacts with fins of the drum to form an anti-rotation stop.

15. A mechanical system for blocking and unblocking a wire element deployment system for assisting in retrieving at least one submerged object from the bottom of a body of water; the wire element deployment system comprising a wire element and a holding device configured, when locked, to allow the wire element to be held in a short position, in which the distance between two ends of the wire element is less than the length of the wire element, and the holding device being configured, when unlocked, to allow the wire element to be deployed,
the first end of the wire element being secured to the holding device and the other end being able to be fastened to at least one object intended to be submerged;
the mechanical blocking and unblocking system being configured to be connected to a control system configured to control the unblocking of the holding device upon receiving an acoustic signal transmitted by an acoustic signal transmission system submerged at the surface,
wherein the mechanical blocking and unblocking system comprises a blocking device comprising a rod, referred to as a finger, mounted so as to be able to move between:
a position referred to as armed position, in which the finger is able to interact with a part of the holding device in order to prevent the deployment of the wire element, and
a position referred to as disarmed position in which the finger is in a position moved away from said part of the holding device in order to allow the wire element to be released; the finger being returned to the disarmed position by a spring;
the mechanical blocking and unblocking system also comprising:
a holding member for holding the finger in the armed position, which can move between a position for holding the finger in the armed position, and a position for releasing the finger;
a mechanism for moving the holding member into the position for releasing the finger; wherein the mechanism for moving the holding member comprises an electromagnet;
the electromagnet being configured, when supplied with electrical power by a battery of the control system, to bring the holding member into the position for releasing the finger.

16. The system as claimed in claim 15, wherein the mechanism for moving the holding member also comprises a mechanical connection system between the electromagnet and the holding member, connected on one side to a movable shaft of the electromagnet, referred to as the core, and on the other side to the holding member, and the electromagnet being configured, when supplied with electrical power, to actuate the mechanical connection system so as to bring the holding member into the position for releasing the finger.

17. The system as claimed in claim 15, wherein said mechanical blocking and unblocking system is in one piece.

18. A system for assisting in retrieving at least one submerged object, the assistance system comprising:
a submersible floating element;
a wire element deployment system with a wire element held in a short position by a holding device, and that can be deployed, of which one end is secured to the holding device and another end is fastened to said at least one submerged object;
a mechanical blocking and unblocking system for preventing and respectively allowing the deployment of the wire element by virtue of a control system that is actuated by an acoustic signal transmission system;
the mechanical blocking and unblocking system comprising a rod mounted so as to be able to move between an armed position, which prevents the deployment of the wire element, and a disarmed position, which releases the wire element, and a rod moving system comprising an electromagnet that, when supplied with electrical power, is configured to disarm the rod.

19. The system as claimed in claim 18, wherein the rod is mounted so as to be able to slide between said armed position and said disarmed position.

20. The system as claimed in claim 18, wherein said mechanical blocking and unblocking system comprises a mechanical connection system connected on one side to a core of the electromagnet, and on the other side to a rod holding member that makes it possible to hold the rod in the armed position.
